(19) United States
(12) Patent Application Publication
(10) Pub. No.: US 2007/0275593 A1
(43) Pub. Date: Nov. 29, 2007

(54) Battery bypassing contact

(76) Inventor: Morris Lucian Barwick, Greenville, TX (US)

Correspondence Address: MORRIS L. BARWICK, 5113 F M 2101, GREENVILLE, TX, 75402, US

(21) Appl. No.: 11/472,932

(22) Filed: Jun. 22, 2006

Related U.S. Application Data
(60) Provisional application No. 60/802,713, filed on May 23, 2006.

(51) Int. Cl. H01R 3/00

(52) U.S. Cl. 439/500

(57) ABSTRACT

The inventive device describes an automatically switching battery contact that directs electrical current through a battery when a battery is present but redirects the electrical current flow past that battery position when no battery is present. This allows assembling of an incremental voltage battery holder for the provision of a battery holder that provides output voltage as a function of the number, as well as types of batteries installed.

### BACKGROUND OF THE INVENTION

My invention is of a contact for a dry cell battery that directs electrical current through the battery when a battery is present but redirects the electrical current flow past that battery position when no battery is present.

This invention has been to solve the problem of a battery powered construction project. This device had desirable performance characteristics when powered by two, three or four AAA type alkaline batteries. It was difficult to find a cost effective switch and since the user would decide in advance which mode he would want today, he could simply add or remove batteries from the battery holder.

It can be appreciated that battery holders have been in use for years. Typically, battery holders are pre-determined to accommodate a given number of batteries.

The main problem with conventional battery holders is that the absence of even one battery breaks the serial chain and no voltage at all is available at the battery holder output terminals.

Another problem with conventional battery holders is that one is committed to the designed voltage of a given battery holder as all positions must be filled and little variation in supplied voltage is possible.

Another problem with conventional battery holders is that occasionally, an odd voltage may be desired and is extremely difficult to acquire a suitable battery holder.

While these devices may be suitable for the particular purpose to which they address, they are not as suitable for the provision of a battery holder that provides output voltage as a function of the number of batteries installed and is not committed to the filling of all battery positions.

In these respects, the BATTERY BYPASSING CONTACT, according to the present invention substantially departs from the conventional concepts and designs of the prior art, and in so doing provides an apparatus primarily developed for the purpose of the provision of a battery holder that provides output voltage as a function of the number of batteries installed. A thorough search of USPTO Classes 429/1, 429/96, 429/97, 429/100 and 439/500 has discovered no prior attempt to provide a bypassing battery contact. Voltage modification in a battery array is attempted in U.S. Pat. No. 5,489,486 but in no instance is a vacant battery position proposed in a serial connection.

### BRIEF SUMMARY OF THE INVENTION

My “BATTERY BYPASSING CONTACT” provides a battery station electrical bypassing path when no battery is present but routes electrical current through the battery when a battery is present. A battery holder of multiple positions can be assembled, using my contacts, and containing a definite number of positions for the installation of batteries of the “AAA”, “AA”, “C” and “D” size, or others.

Each battery station may or may not contain a battery and thereby an array can provide output voltage as a function of the sum of number of batteries present and the voltage of each.

In an array of 4 battery positions, by mixing quantity and presence of 1.5-Volt and 1.2-Volt batteries, the array output voltages available are:

| | |
|---|---|
| PRESENCE | |
| OF EACH | |
| BATTERY | TOTAL VOLTS |

| | | | | |
|---|---|---|---|---|
| 1.2 | | | | 1.2 |
| 1.5 | | | | 1.5 |
| 1.2 | 1.5 | | | 2.7 |
| 1.5 | 1.5 | | | 3 |
| 1.2 | 1.2 | 1.5 | | 3.9 |
| 1.5 | 1.2 | 1.5 | | 4.2 |
| 1.5 | 1.5 | 1.5 | | 4.5 |
| 1.2 | 1.2 | 1.2 | 1.2 | 4.8 |
| 1.2 | 1.2 | 1.2 | 1.5 | 5.1 |
| 1.5 | 1.2 | 1.2 | 1.5 | 5.4 |
| 1.5 | 1.2 | 1.5 | 1.5 | 5.7 |
| 1.5 | 1.5 | 1.5 | 1.5 | 6 |

It is also noted that when used to power an Electrostatic Discharge sensitive circuit, ESD, when no battery is present, the circuit is protected by the positive input buss shorted to the negative input buss.

In view of the foregoing disadvantages inherent in the known types of battery holders now present in the prior art, the present invention provides a new incremental voltage battery holder construction wherein the same can be utilized for the provision of a battery holder which provides output voltage as a function of the number of batteries installed.

The general purpose of the present invention, which will be described subsequently in greater detail, is to provide a new incremental voltage array when used on a printed wiring board or in battery holder that has many of the advantages of the holders mentioned heretofore and many novel features that result in a new incremental and selectable voltage battery holder which is not anticipated, rendered obvious, suggested, or even implied by any of the prior art, either alone or in any combination thereof.

To attain this, the present invention generally comprises a Normally Closed shorting battery contact that provides an alternate path for electrical current to pass directly from the negative contact to the positive contact when no battery is present. The installation of a battery physically interferes with the NC contact, causing it to open and thereby allowing electrical current to pass through said battery with the corresponding increase of voltage contributed by that battery.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an incremental voltage battery holder that will overcome the shortcomings of the prior art devices.

Another object is to provide an incremental voltage battery array that allows the use of any quantity of batteries desired in a universal type holder and thereby achieve the desired DC voltage.

Another object is to provide an incremental voltage battery holder so that in that the absence of one of several required batteries for an application it will still allow an attempt of continued operation of a device, although at reduced voltage.

Another object of my invention is to provide an incremental voltage battery holder that allows the revision of operating voltage in an existing device by the removal or addition of batteries, thereby modifying performance characteristics.

Another object is to provide an incremental voltage battery holder that will allow more refined voltage by the quantity of 1.5-volt batteries and 1.2-volt batteries.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is the schematic of any single battery station when no battery is present showing the current flow path bypassing that station.

FIG. 2 is the schematic of said battery station when a battery is present, resulting in operation in the conventional mode of passing the current through the battery.

FIG. 3 is the schematic of a battery holder of 6 stations when only two batteries are present. The output voltage is the sum of the two batteries.

FIG. 4 is an isometric view of the construction details of my preferred embodiment of a switching battery contact.

FIG. 5 is the contact of FIG. 4 having been deflected by the installation of a battery and opening the NC contacts.

FIG. 6 is my contact of FIG. 4 when in contact with an installed battery and is deflected to open the NC contacts.

FIG. 7 is an alternate embodiment of my invention showing a single clip to be used in an array of batteries on a planar surface.

FIG. 8 is the use of my alternate embodiment of FIG. 7 in a multiple battery, series connected, array.

### DESCRIPTION OF THE PREFERRED EMBODIMENT

Turning now descriptively to the drawings, in which similar reference characters denote similar elements throughout the several views, the attached figures illustrate a battery contact that is basically a normally closed contact switch. If a battery is present, the NC contact is automatically opened by physical interference and current flow is diverted through the battery. If the battery is removed, the contact closes and the current flow bypasses that battery position with no voltage increase.

It has been noted earlier that the output voltage of a battery array can be modified by the selection of type and quantity of installed batteries.

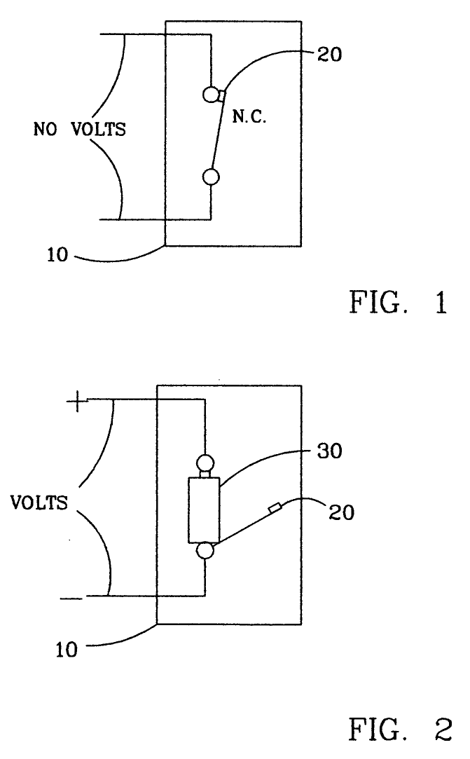

FIG. 1 depicts the schematic of each battery station 10 in the absence of an installed battery. Item 20 is a Normally Closed contact switch, which is conductive past the battery station. Note that the output conductors are shorted together.

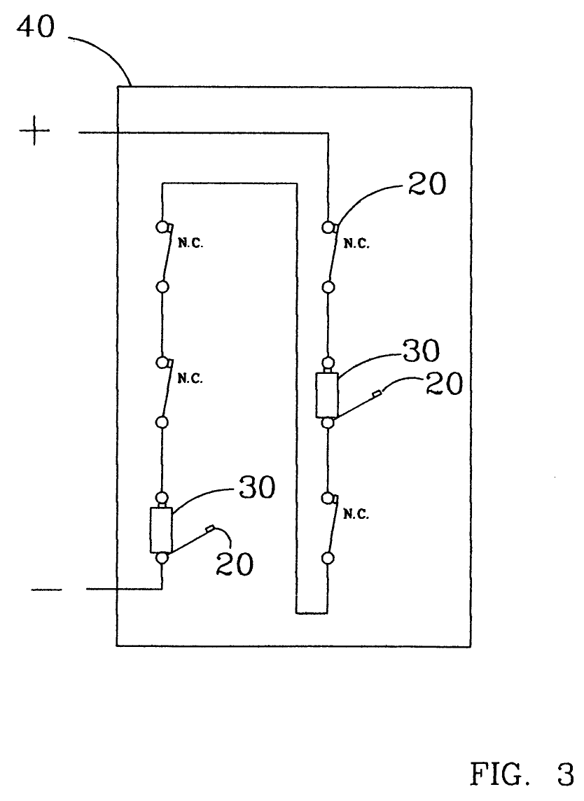

FIG. 2 depicts the schematic of each battery station in the presence of an installed battery 30. Item 20 has been forced open by the presence of the installed battery 30 thereby deleting conductivity across the station. At this time battery voltage appears across the battery station.

FIG. 3 is a 6-position battery array 40. A battery is installed in two random positions. Output voltage of the array is the sum of the two batteries due to the N.C. contacts passing current through unused positions.

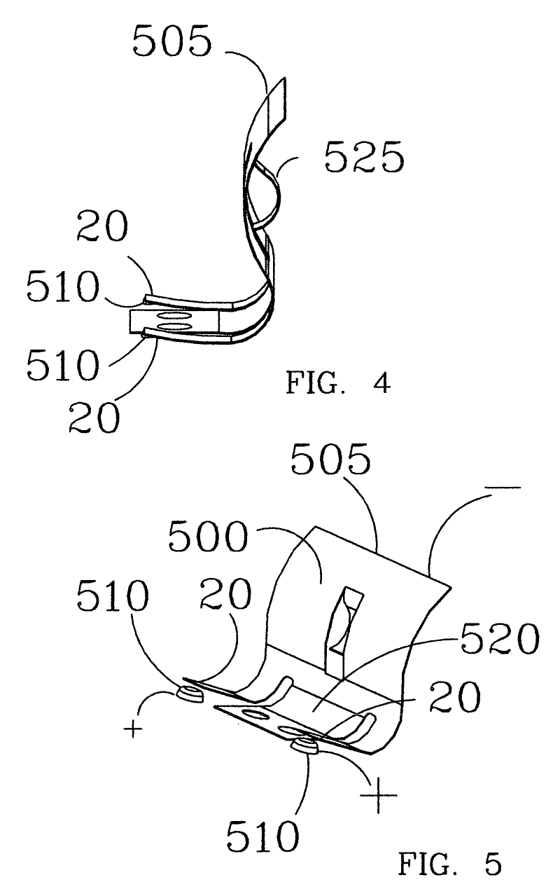

FIG. 4 is the preferred embodiment of my invention. Contact 505 is the contact that is destined for being conductive to the negative end of an installed battery. The battery station negative output conductor is electrically attached to 505. Lanced clip 525 can receive the positive terminal of a prior battery if present. Before battery installation, contact 505 is electrically conductive with positive contact 510 at interface 20. Contact 510 is electrically conductive with the battery positive contact and also the positive output conductor.

FIG. 5 is the contact of FIG. 4 but deflected as a cantilever beam in the vicinity of 520 by the presence of a battery. The side portions are not constrained and so rotate with the upper portion of the clip. This rotation lifts the NC contact side portions 20 of 505 from the positive side of the battery station 510 and thereby opens the bypassing path. This places the battery in the path of through electrical current flow.

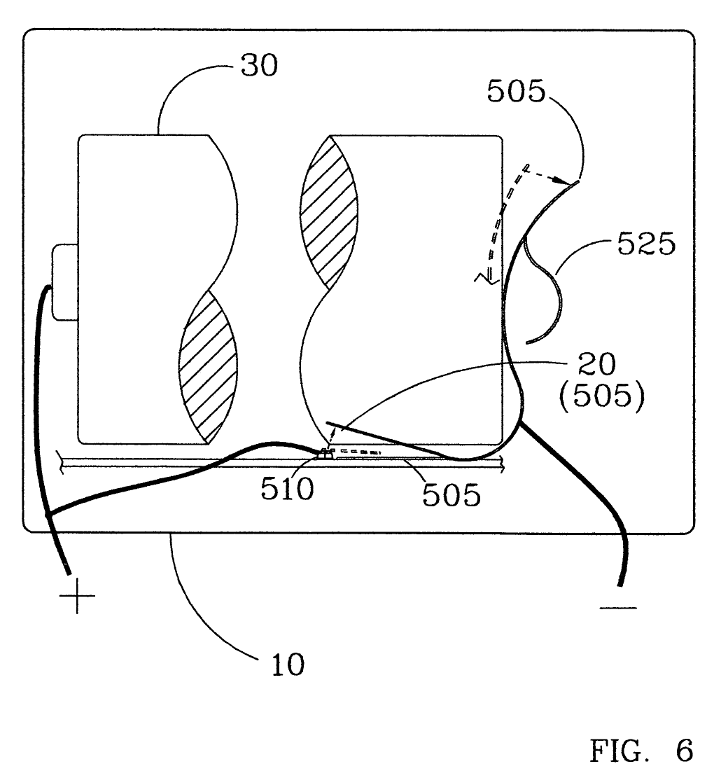

FIG. 6 is a battery 30, in place and having deflected contact 505 away from contact 510 at 20 resulting in a current path thru the battery in a normal mode. When a battery is installed, the length of the battery forces contact 505 to flex resulting in the electrical separation of 505 and 510 at 20.

### A Brief Description of my Alternate Embodiment

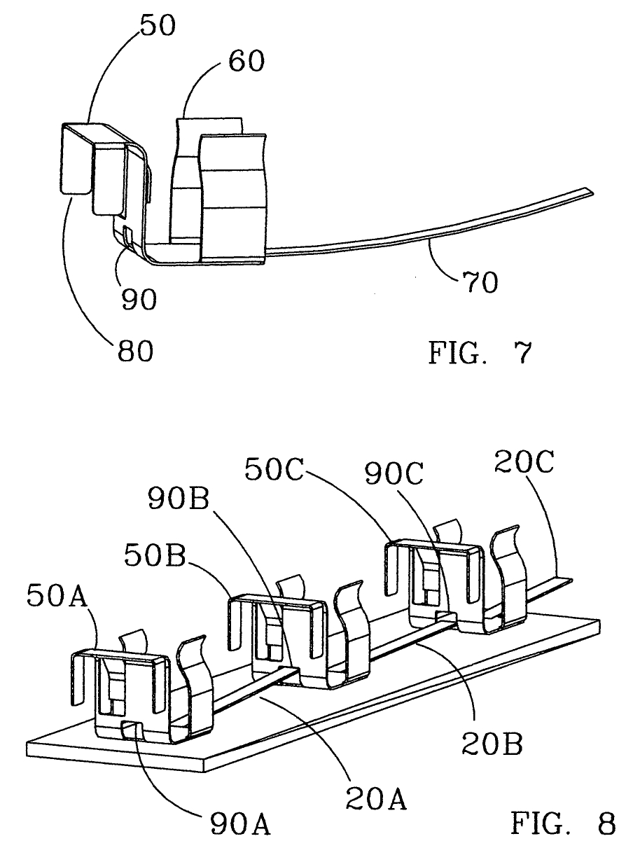

FIG. 7 is an alternate embodiment of my invention specifically intended to accommodate numerous batteries in series on a planar surface. Clip 50 is used between batteries. Construction details are of the two battery holding clips 60, the shorting bar 20, which is inserted into hole 90 in the next clip, and the two battery retaining tabs 80. The battery retaining tabs 80 also serve to assure the NC actuating end of the battery, the positive in this design, is inserted first. This assures contact 20 will “break before make” in order to prevent shorting of the battery during installation.

FIG. 8 is of three clips of my alternate embodiment 50A, 50B and 50C used in tandem accommodating two batteries. The clip 50A contains no battery so its shorting bar 20A is sprung up to short at the hole 90 B in the next position. The next clip 50B contains a battery, not shown, and the shorting bar 20 B is forced down away from the top edge of hole 90C and no longer makes contact across that battery location. Electrical current flowing into 50A passes thru to 50B. At 50B the flowing current passes thru the battery and on to 50C.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A battery contact clip which passes electrical current therethrough when no battery is present but upon installation of a of a battery therein disconnects the pass through current and inserts the battery into the pass through circuit allowing the voltage of said battery to be added to the flowing current from other battery contact clips and making possible a battery holder that allows the installation of a battery in any or all positions in an array of battery contact clips with a resulting array output voltage as a function of the number and voltages of installed batteries.
